(19) United States
(12) Patent Application Publication
(10) Pub. No.: US 2002/0103566 A1
(43) Pub. Date: Aug. 1, 2002

(54) Computerized, custom-fit garment pattern production system for automatic garment pattern extrapolation or interpolation based upon changes in indirect body dimension parameters

(76) Inventor: Gregory Pierce Gadson, Noblesville, IN (US)

Correspondence Address: Gregory P. Gadson, Esq., 19375 Amber Way, Indianapolis, IN, 46060, US

(21) Appl. No.: 09/774,408

(22) Filed: Jan. 31, 2001

(51) Int. Cl. G06F 19/00

(52) U.S. Cl. 700/132

(57) ABSTRACT

A computerized garment pattern production system automatically extrapolates or interpolates the dimensions of an existing garment pattern for a new custom-fitting garment upon the input of changes in a customer's stored indirect parameters. In a preferred embodiment, along with a customer's body dimensions, the customer's weight is also stored in his/her profile. When a customer who has gained weight (or lost weight) since his/her body dimensions were stored orders a new garment, the dimensions of the pattern are automatically extrapolated (or interpolated) according to a stored algorithm and the new weight to surmise new body and hence pattern dimensions. Therefore, a customer with a stored profile ordering new garments need merely supply his/her new weight, and need not have his/her body dimensions re-measured. The present invention better facilitates custom garment ordering from remote locations via telephone, the Internet, and the like for customers with stored profiles. In an alternate embodiment, a different extrapolation/interpolation algorithm is used depending on a customer's identified body type (e.g., endomorph, ectomorph, mesomorph) to better predict changes in body dimensions due to weight changes. Further aspects include for children and growing young adults, the inclusion of height data as an indirect parameter in a customer's stored profile.

### BACKGROUND OF THE INVENTION

1. Field of the Invention

The present invention generally relates to computerized garment pattern systems. More particularly, the present invention relates to computerized garment pattern systems for the computer generation of patterns for custom-fit garments.

2. Background

Prior art computerized pattern generation/production systems allow a system operator (such as a tailor, seamstress, or the like) to enter the body dimensions of a customer and cause special pattern generation software to generate the patterns needed for cutting, joining and sewing fabric for custom-fit apparel. Basic systems are described, for example, in U.S. Pat. No. 4,149,246 issued to Goldman and U.S. Pat. No. 4,598,376 issued to Burton, et al. Such systems have been further refined by particular methods of converting body dimensions into the various measurements of the actual patterns, as exemplified by U.S. Pat. No. 4,926,344 issued to Collins, et al. Some more comprehensive systems have even focused on obtaining more accurate and extensive body measurements for better fitting garments, as exemplified by U.S. Pat. No. 5,956,525 issued to Minsky.

Recent changes and trends in apparel commerce (e.g., catalog sales via the telephone, the Internet, etc.) practices have led to the increase in apparel sales to remotely located customers. Unfortunately, such customers are generally limited to “off-the-rack” garments which are not custom fitting. Customers of course have the option of being measured by a tailor or seamstress prior to having that professional make custom-fitting apparel. Even with the existence of computerized pattern production systems, the customer must still either be measured, or the professional must rely upon old measurement data provided, which may or may not be reliable.

Computerized garment pattern generation systems provide good results for repeat customers who have previously obtained high quality body measurements, and whose body dimensions have not changed since their measurements were stored in the system. This allows such a customer to remotely order custom-fitting apparel without having to be re-measured.

Where the customer's body dimensions have changed due to weight gain, weight loss and the like, a customer must either be re-measured or have garments constructed based upon outdated measurements. Such a customer would therefore not be able to remotely order custom-fitting apparel using prior art systems.

There is a great and unmet (by the prior art) need to allow a customer who has his/her body dimensions stored in a computerized pattern generation program to continue to order and have high-quality custom-fitting garments constructed on his/her behalf without having to be re-measured prior to placing the order, in the case where his/her body dimensions have changed since being stored in the program.

### SUMMARY OF THE INVENTION

In view of the aforementioned problems and deficiencies of the prior art, the present invention provides a computerized garment pattern production method for producing garment patterns for custom-fit garments. The method at least includes the steps of establishing a customer profile for storing customer data, storing a plurality of customer body dimensions in the customer profile, and storing in the customer profile, one or more indirect parameters indirectly related to body dimensions.

The method also at least includes the steps of producing a garment pattern for a custom-fitting garment based upon the body dimensions, and automatically extrapolating or interpolating the dimensions of a pattern according to an extrapolation/interpolation algorithm in response to a change in an indirect parameter.

The present invention also provides a computerized garment pattern production system for producing garment patterns for custom-fit garments. The system at least includes memory adapted to store a customer profile at least including customer data, including a customer's body dimensions, and one or more indirect parameters indirectly related to body dimensions, and a garment pattern producer adapted to produce a garment pattern for a custom-fitting garment based upon the body dimensions.

The system also at least includes a pattern extrapolator/interpolator coupled to the garment pattern producer, and adapted to automatically extrapolate or interpolate the dimensions of a pattern according to an extrapolation/interpolation algorithm in response to a change in an indirect parameter.

The present invention additionally provides a method of ordering and producing custom-fit garments. The method at least includes the steps of establishing a customer profile for storing customer data, storing a plurality of customer body dimensions in the customer profile, and storing in the customer profile, one or more indirect parameters indirectly related to body dimensions.

The method also includes the steps of establishing an Internet connection between a customer and an instrumentality of an Internet merchant, via the Internet connection, the customer inputting a current value of one or more of the indirect parameters, and via the Internet connection, the customer ordering a custom-fit garment.

The method additionally includes the steps of producing a garment pattern for a custom-fitting garment based upon the body dimensions, automatically extrapolating or interpolating the dimensions of a pattern according to an extrapolation/interpolation algorithm in response to a change in an indirect parameter, and producing the custom-fit garment according the pattern.

### BRIEF DESCRIPTION OF THE DRAWING FIGURES

Features and advantages of the present invention will become apparent to those skilled in the art from the description below, with reference to the following drawing figures, in which:

FIG. 1 is a schematic block diagram of the present-inventive computerized garment pattern production system for custom-fit garments;

FIG. 2 is a flowchart detailing the present-inventive method for the computerized production of a garment pattern for custom-fit garments;

Supplemental to FIG. 2, FIG. 2A lists additional steps used by the present invention when customer orders are placed via the Internet, and the like;

FIG. 3 is an example of a simple interpolation/extrapolation function which can be used by the present invention to calculate body dimension changes when customer weight changes have occurred; and

FIG. 4 is an example of two simple interpolation/extrapolation functions that can be used by the present invention to calculate body dimension changes when a customer's weight changes, in a case where all body dimensions are not expected to vary identically.

### DESCRIPTION OF THE PREFERRED EMBODIMENTS

Used throughout this letters patent, the term “indirect parameter” means something that does not express a body dimension used to create a garment pattern, but has a correlation to such a body dimension; or something in which the manner that it changes affects the manner in which a body dimension used in a garment pattern changes.

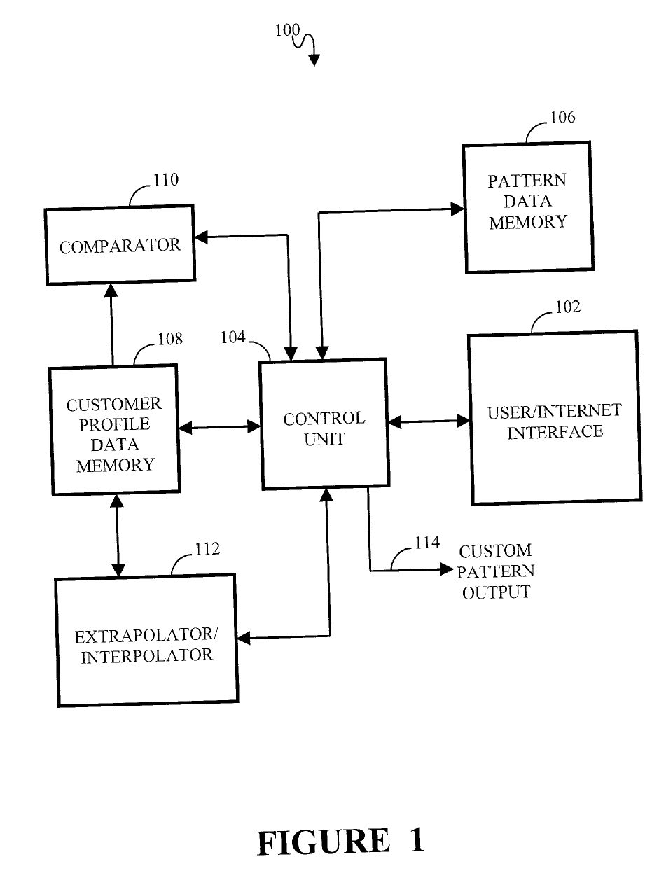

Implemented with the aid of a programmed computer (e.g., microcomputer) the custom-fit pattern production system 100 is schematically diagrammed in FIG. 1. The general components of the system include the following major elements: a user interface 102 allowing a user (such as a tailor, seamstress, employee, or even a customer, etc.) to interface with the computer and the software as is known in the art; a control unit 104 handling the overall operation of the hardware and software implementing the system 100; a pattern data memory 106 for storing pattern design and data information necessary for constructing patterns used for making a variety of garments as a matter of design choice; a customer profile data memory 108 for storing for each customer for which patterns can be produced by the system 100, detailed body dimension data and indirect parameter data, such as the customer's weight, body type, etc.; a comparator 110 for comparing the values of stored indirect parameters with new values received from the user interface, for example, to determine if any changes in the indirect parameters exceed a predefined maximum; and an extrapolator/interpolator 112 for when triggered, automatically extrapolating or interpolating a customer's body dimensions according to an algorithm determined by indirect parameter data and the control unit 104.

The custom pattern output by the system 100 (at output 114) can be sent to a large printer or stored for future use.

The interface 102 also symbolically represents the connection between an Internet customer via a personal computer, for example, and the web site of a merchant who produces custom-fit garments according to the present invention. Details will be given infra regarding this aspect of the present invention.

In the operation of the system 100, a customer's detailed body measurements are made and stored in a unique customer profile prior to producing custom-fit patterns. When a user requests the production of garment patterns for a custom-fitting garment, he/she chooses from a stored library of garments. Where weight has been used as an indirect parameter, the user also enters the customer's current weight. In the preferred embodiment the system designer can specify a maximum parameter variation beyond which an extrapolation or interpolation of a customer's stored body dimensions may not be valid. That is, when an indirect parameter changes by an unacceptably large amount, the user is alerted to the fact that any patterns produced may not provide a garment with a good fit.

In the preferred embodiment, the extrapolation/interpolation algorithm varies the body dimensions in the customer profile when the customer's weight has changed, and uses an algorithm dictated by the stored body type of the customer. For example, some body types tend to have more evenly distributed dimension increases accompanying weight, whereas other body types may have dimension increases more concentrated in certain areas (e.g., waist, hips, etc.) accompanying weight gain. Further, a weight gain by a customer who has been under a certain weight (perhaps an “ideal” weight) may be more likely to have the new weight more evenly distributed than a customer who was already above a certain weight. Among the body types which can be used are the following initially proposed by W. H. Sheldon: endomorphic; mesomorphic; and ectomorphic. It will be appreciated by those skilled in the art that the body type classifications need not be limited to the above examples.

For example, a mesomorphic male who was “underweight” when his last body measurements were taken and stored might be expected to have substantially all of his horizontal dimensions increased directly proportional to the percentage of his weight gain. An endomorphic female who was already at or beyond a certain weight when her body dimensions were last taken and stored might be expected to have a disproportionate increase in hip measurements, for example.

In an alternate embodiment, the customer profile can also contain a history of body measurements and associated weights for long-term customers to give a better prediction of body dimensions by the extrapolation/interpolation algorithms.

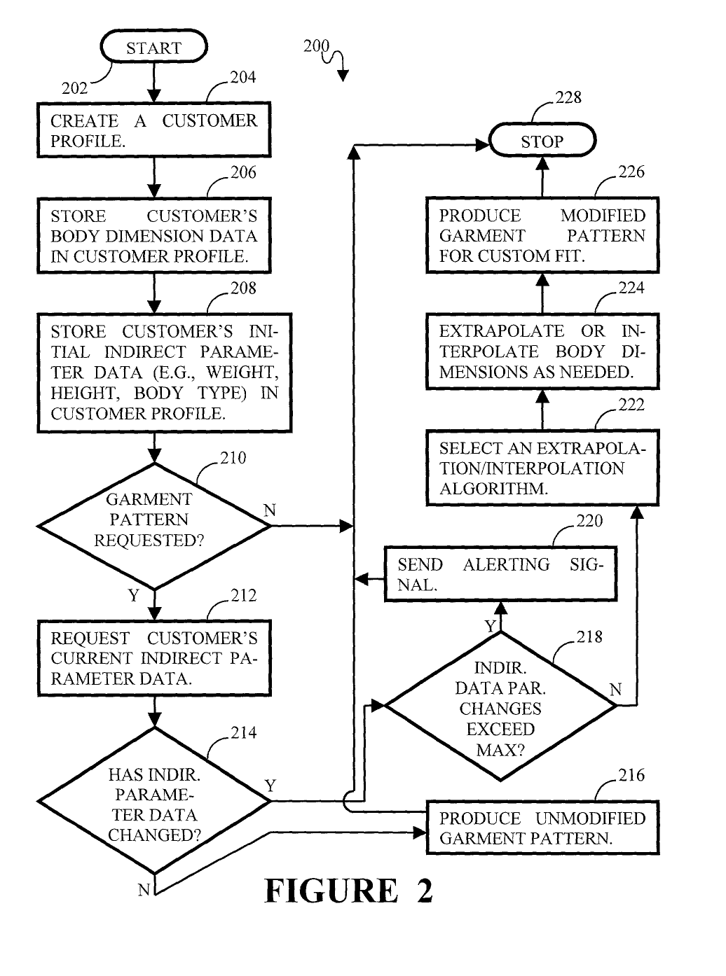

Turning to FIG. 2, a flowchart 200 illustrates the method used by the present-inventive system for the production of garment patterns for custom-fitting garments when an indirect parameter (such as weight) has changed since the customer was last measured, while not requiring new body measurements.

After the start 202 of the program 200, a detailed customer profile is created, including the customer's body dimensions (Step 204), and indirect parameter data such as the customer's weight (Step 206). If the user requests the production of a garment pattern for a particular garment, the system requests current indirect parameter information such as the customer's current weight (Steps 210 and 212). If the customer's weight or other important indirect parameter has not changed, the garment pattern is produced without any extrapolation or interpolation of the customer's body dimensions (Steps 214 and 216).

If the customer's weight or other important indirect parameter data has changed, a determination is made as to whether the change exceeds a predefined maximum (e.g., twenty percent), beyond which a prediction of current body dimensions may not be valid (Step 218). If the maximum has been exceeded, the user is warned that a garment produced without making new measurements may not have a custom fit (Step 220). Thereafter, the user can continue or stop the program (Step 228).

Where the predefined maximum has not been exceeded, the system selects an appropriate extrapolation/interpolation algorithm based upon such indirect parameters as body type (Step 222). The body dimensions are extrapolated or interpolated as needed in Step 224. Finally, the modified body dimension data is used by the system 100 to construct the desired pattern (Steps 226 and 228).

As the present invention is also directed to a method of ordering custom-fit garments via wide area networks such as the Internet, and other electronic methods, additional related steps to the algorithm 200 are illustrated in FIG. 2A. Between Steps 208 and 210 of the algorithm 200 is Step 209. In that step, a customer connects via the World Wide Web to a web site administered by a merchant who produces custom-fit garments according to the present invention. In an alternate embodiment, the customer can place orders via other methods such as through electronic mail (“e-mail”), telephone, facsimile machine or regular mail.

Between Steps 214 and 216 of the algorithm 200 are Steps 215.1 and 215.2. In the preferred embodiment, the customer confirms the order in Step 215.1 while connected to the web site. The order is finalized by billing the appropriate charges to the customer's credit card account or other account in Step 215.2. Recall from FIG. 2 that these steps are for ordering garments where there are no changes to the indirect parameters.

Between Steps 218 and 222 of the algorithm 200 are Steps 221.1 and 221.2. In the preferred embodiment, the customer confirms the order in Step 221.1 while connected to the web site. The order is finalized by billing the appropriate charges to the customer's credit card account or other account in Step 221.2. These steps apply when there have been changes in an indirect parameter, but the change has not exceeded a predetermined maximum.

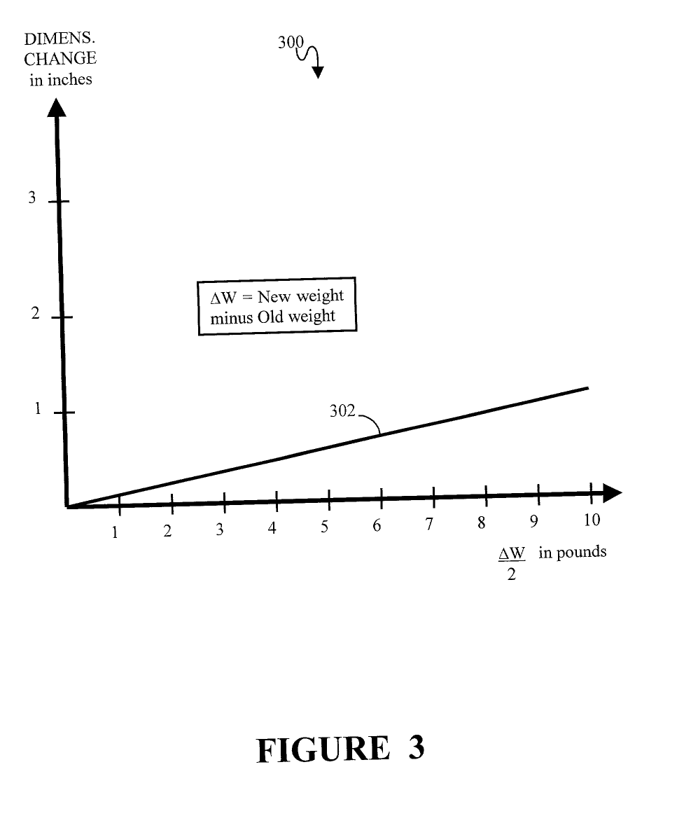

FIG. 3 shows a representation 300 of a simple interpolation/extrapolation algorithm used to convert changes in body dimensions to new pattern dimensions. In the example, a linear curve 302 shows the relationship between the predicted change in a dimension such as a waist measurement or other horizontal dimension, and a customer's weight changes. More specifically, the abscissa represents one-half of the change in the customer's weight. The algorithm 300 predicts that for a custom fit, a customer who previously weighed 180 pounds, but is 190 when a new order is placed, will need an extra one-half inch in the waist, since ΔW/2=(190−180)/2=5 pounds, and an abscissa value of 5 pounds leads to an approximate ordinate value of 0.5 inches.

It should be appreciated by those skilled in the art that the interpolation/extrapolation algorithm represented by FIG. 3 is but one of numerous possibilities. The algorithms may involve numerous slopes, and need not even be linear, as exponential algorithms are perfectly suited for the present invention. If desired, a separate interpolation/extrapolation algorithm may be used for every body dimension that might be expected to change with changes in the indirect parameters.

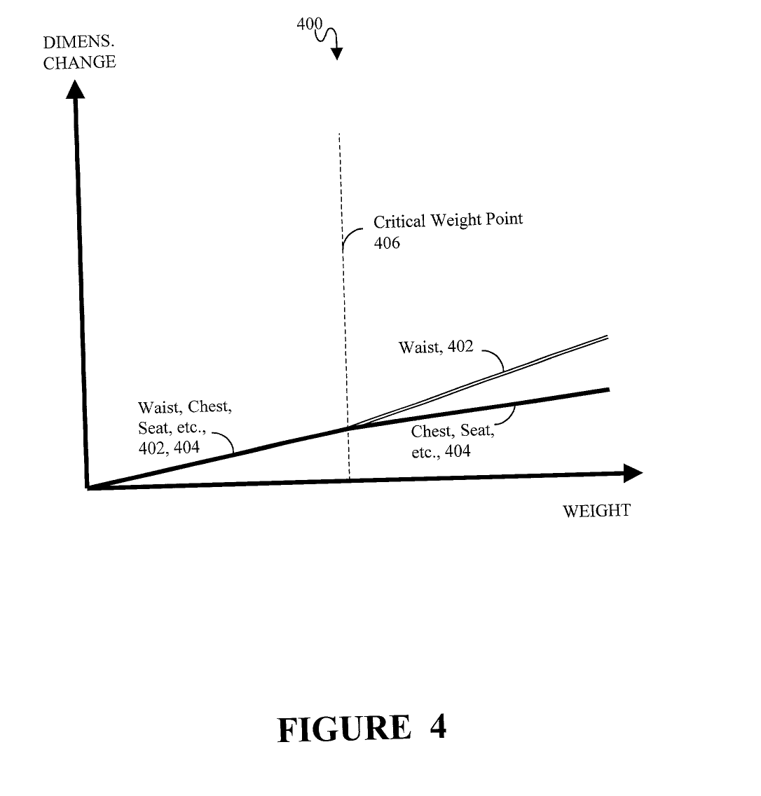

Recall from the discussion, supra, that a different interpolation/extrapolation algorithm can be used depending on the identified body type of the customer to yield more accurate dimension predictions. For example, the interpolation/extrapolation algorithm for predicting the waist increases of an endomorphic male might have a steeper slope (or might even be exponential) than that of the algorithms for predicting other body dimensions such as the chest, seat, etc. In contrast, the horizontal body dimensions of an ectomorphic male of normal weight might expect to increase proportionally with moderate weight increases. Therefore, it is possible that a simple linear algorithm might suffice for this latter case. FIG. 4 shows a more complicated interpolation/extrapolation algorithm 400 that might be used for endomorphic males. In this algorithm, all of the horizontal measurement interpolations/extrapolations such as the waist, chest, seat, etc. are made using the segment 402, 404, when the customer weighs less than a critical weight 406, indicating that these measurements are expected to vary in the same manner in this weight range. The critical weight can be an ideal weight. When the customer's weight is beyond the critical weight point, a bifurcated approach is taken. Since more of the new weight might be expected to be gained in the waist area, the waist interpolation/extrapolation portion 402 has a higher slope than the previous segment 402, 404, while the segment 404 governing the chest and seat dimensions has a lower slope than the combined segment 402, 404, since less of the new weight is expected to settle in the chest and seat areas.

Variations and modifications of the present invention are possible, given the above description. However, all variations and modifications which are obvious to those skilled in the art to which the present invention pertains are considered to be within the scope of the protection granted by this Letters Patent.

For example, the present invention can be used for producing garments for both female and male customers, and the aspects of the present invention related to body types can be applied in a gender-specific way.

Height can also be used as an indirect parameter for children and growing young adults.

What is claimed is:

1. A computerized garment pattern production method for producing garment patterns for custom-fit garments, said method comprising the steps of:
establishing a customer profile for storing customer data;
storing a plurality of customer body dimensions in said customer profile;
storing in said customer profile, one or more indirect parameters indirectly related to body dimensions;
producing a garment pattern for a custom-fitting garment based upon said body dimensions; and
automatically extrapolating or interpolating the dimensions of a pattern according to an extrapolation/interpolation algorithm in response to a change in an indirect parameter.

2. The method in claim 1, wherein said indirect parameters include a customer's weight.

3. The method in claim 1, wherein said indirect parameters include a customer's height.

4. The method in claim 1, further comprising the step of:
choosing said extrapolation/interpolation algorithm according to a customer's identified body type.

5. The method in claim 1, further comprising the steps of:
disabling said producing and automatically extrapolating or interpolating steps when the change in an indirect parameter exceeds a predefined maximum.

6. The method in claim 1, further comprising the steps of:
disabling said producing and automatically extrapolating or interpolating steps when the change in an indirect parameter exceeds a predefined maximum; and
producing a user-perceivable alert signal informing a system user that an indirect parameter change exceeds a maximum, and that the customer's body dimensions must be re-measured before a new garment pattern can be produced.

7. The method in claim 1, wherein said indirect parameters include a customer's weight, and said method further comprises the step of:
choosing said extrapolation/interpolation algorithm according to a customer's identified body type.

8. A computerized garment pattern production system for producing garment patterns for custom-fit garments, said system comprising:
memory adapted to store a customer profile comprising customer data, including a customer's body dimensions, and one or more indirect parameters indirectly related to body dimensions;
a garment pattern producer adapted to produce a garment pattern for a custom-fitting garment based upon said body dimensions; and
a pattern extrapolator/interpolator coupled to said garment pattern producer, and adapted to automatically extrapolate or interpolate the dimensions of a pattern according to an extrapolation/interpolation algorithm in response to a change in an indirect parameter.

9. The system in claim 8, wherein said indirect parameters include a customer's weight.

10. The system in claim 8, wherein said indirect parameters include a customer's height.

11. The system in claim 8, further comprising:
an extrapolation/interpolation algorithm selector adapted to choose said extrapolation/interpolation algorithm according to a customer's identified body type.

12. The system in claim 8, further comprising:
a disabler coupled to said garment pattern producer and said extrapolator/interpolator adapted to disable said garment pattern producer and said extrapolator/interpolator when the change in an indirect parameter exceeds a predefined maximum.

13. The system in claim 8, further comprising:
a disabler coupled to said garment pattern producer and said extrapolator/interpolator adapted to disable said garment pattern producer and said extrapolator/interpolator when the change in an indirect parameter exceeds a predefined maximum; and
an alert signal producer adapted to produce a user-perceivable alert signal informing a system user that an indirect parameter change exceeds a maximum, and that the customer's body dimensions must be re-measured before a new garment pattern can be produced.

14. The system in claim 8, wherein said indirect parameters include a customer's weight, and said system further comprises:
an extrapolation/interpolation algorithm selector adapted to choose said extrapolation/interpolation algorithm according to a customer's identified body type.

15. A method of ordering and producing custom-fit garments, said method comprising the steps of:
establishing a customer profile for storing customer data;
storing a plurality of customer body dimensions in said customer profile;
storing in said customer profile, one or more indirect parameters indirectly related to body dimensions;
establishing an Internet connection between a customer and an instrumentality of an Internet merchant;
via said Internet connection, said customer inputting a current value of one or more of said indirect parameters;
via said Internet connection, said customer ordering a custom-fit garment;
producing a garment pattern for a custom-fitting garment based upon said body dimensions;
automatically extrapolating or interpolating the dimensions of a pattern according to an extrapolation/interpolation algorithm in response to a change in an indirect parameter; and
producing said custom-fit garment according to said pattern.

16. The method in claim 15, wherein said indirect parameters include a customer's weight.

17. The method in claim 15, wherein said indirect parameters include a customer's height.

18. The method in claim 15, further comprising the step of:
choosing said extrapolation/interpolation algorithm according to a customer's identified body type.

19. The method in claim 15, further comprising the steps of:
disabling said producing and automatically extrapolating or interpolating steps when the change in an indirect parameter exceeds a predefined maximum.

20. The method in claim 15, further comprising the steps of:
disabling said producing and automatically extrapolating or interpolating steps when the change in an indirect parameter exceeds a predefined maximum; and
producing a user-perceivable alert signal informing a system user that an indirect parameter change exceeds a maximum, and that the customer's body dimensions must be re-measured before a new garment pattern can be produced.

21. The method in claim 15, wherein said indirect parameters include a customer's weight, and said method further comprises the step of:
choosing said extrapolation/interpolation algorithm according to a customer's identified body type.
